(19) United States
(12) Patent Application Publication
(10) Pub. No.: US 2010/0108235 A1
(43) Pub. Date: May 6, 2010

(54) COATING FOR ARCHITECTUAL PIECES, COATED PECES, AND METHODS OF MAKING AND USING THEM

(76) Inventor: Ronald L. Parmley, St. Louis, MO (US)

Correspondence Address: Polster, Lieder, Woodruff & Lucchesi, L.C., 12412 Powerscourt Dr. Suite 200, St. Louis, MO, 63131-3615, US

(21) Appl. No.: 12/532,610

(22) PCT Filed: Mar. 24, 2008
(86) PCT No.: PCT/US08/57999

§ 371 Date: Sep. 22, 2009

Related U.S. Application Data
(60) Provisional application No. 61/015,661, filed on Dec. 20, 2007.

(30) Foreign Application Priority Data
Mar. 22, 2007 (US) 11726475

(51) Int. Cl. B44C 3/12; C08L 67/00; C08K 5/11; C08K 5/1515; B32B 13/04; B32B 23/04; B32B 21/04; B32B 17/08

(52) U.S. Cl. 156/63; 524/599; 524/314; 524/310; 524/322; 524/114; 428/452; 428/532; 428/535; 428/439

(57) ABSTRACT

A peelable thermoplastic coating (36) applied to one face of an architectural piece (14) such as brick, concrete paver and veneer, and tile. A spray applicator (10) automatically applies the coating substantially edge-to-edge of the face of the piece. A method for grouting the architectural pieces includes applying the grout over the coated faces of pieces arranged in spaced-apart patterns and spreading the grout into the spaces, and peeling the coating from the pieces. In another embodiment, the coated faces are adhered to a form liner, grout or cement is applied to the backs of the pieces and between them, and the form liner and coatings are stripped from the pieces.

### CROSS-REFERENCE TO RELATED APPLICATIONS

This application is a continuation-in-part of pending application U.S. Ser. No. 11/726,475, filed Mar. 22, 2007 and claims the benefit of Provisional application 61/015,661, filed Dec. 20, 2007. It incorporates by reference the disclosures of those applications and the disclosure of application U.S. Ser. No. 11/471,131, filed Jun. 20, 2006, now abandoned.

### STATEMENT REGARDING FEDERALLY SPONSORED RESEARCH

Not Applicable.

### TECHNICAL FIELD

The present invention relates to a coating, and in particular to a coating for architectural pieces used in the construction industry and remodeling of existing buildings. It also relates to the coated pieces, methods of making the coated pieces, and methods of using the coated pieces. The architectural pieces are preferably masonry pieces such as bricks, concrete blocks, pavers, stones, and tiles, both as structural elements and especially as veneers; the pieces may also, in some embodiments of the invention include plastics, polyurethanes, wood, and glass decorative items, wood inlays, and wood flooring products. The invention has particular application to architectural pieces which are placed in a spaced-apart pattern and the spaces between them grouted.

### BACKGROUND ART

In the conventional practice of performing grouting work, one sees the bricklayer on his knees placing each brick on the surface to be covered, while extruding grout from a funnel shaped, hand-held supply of grout. He then smoothes the grout by hand between the brick or stone, allows the grout to cure, and subsequently washes and polishes the brick or stone to remove any excess grout before applying a finishing coating.

The laying of brick, concrete, or stone veneer whether it be on a wall, a driveway or a patio, is a highly skilled occupation, commanding high wages. The level of skill required, and the time-consuming nature of conventional brick or stone veneer installation render the process very expensive. As a result, the use of brick or stone veneer occurs only in those areas where it is nearly indispensable, e.g., fireplace surrounds or decorative exterior wall fronts. Because the industry of laying architectural pieces, such as brick or stone veneer, is so labor intensive, shortcuts have been considered but heretofore have not been found to be effective. Examples of such approaches are found in U.S. Pat. No. 1,994,644 to N. P. Harshberger and U.S. Pat. No. 5,740,653 to Leonid Dubizhansky. Additionally, brick has been coated with a thin coat of wax to protect the brick during grouting. This approach is largely ineffective and requires the use of high-temperature steam to melt and remove the wax coating after grouting.

Although the grouting of tile is somewhat similar to that of brick or stone veneer, the tile has a slick surface and therefore is easier to clean after grouting. Nonetheless, grouting tile inevitably leaves a grout film on the tile, which must be carefully removed.

### DISCLOSURE OF INVENTION

The present invention provides an architectural piece having a thermoplastic coating substantially completely covering an upper surface thereof, all other surfaces of the architectural piece being substantially free of the thermoplastic coating, the thermoplastic coating being peelable intact from the architectural piece. In addition, the invention relates to a coating especially formulated for coating the architectural pieces, to a method for coating the architectural pieces, and to a method of grouting, mortaring or otherwise filling spaces between elements of the architectural pieces.

The preferred coating comprises major portions of a thermoplastic resin and a plasticizer and may include minor portions of a stabilizer and a release agent, all in such proportions that the resulting mixture when mixed and melted, applied hot to the upper surface of the architectural piece, and cooled provides a coating covering the upper surface of the architectural piece. The coating preferably has a softening point above about 170° F. (77° C.), has a low friction surface, is waterproof, has a low tack, and is peelable from the architectural piece intact by hand or with simple portable tools such as a compressed air hose. Preferred coatings are biodegradable and recyclable; they can also be made of renewable resources rather than petroleum-based constituents.

Preferred coatings include about 25-50% of a cellulosic resin, about 40-72% of a plasticizer, and about 0-5% of a slip agent (stabilizer and/or release agent). The coatings may also include an extender. In an embodiment, the coatings include about 28-50% of a cellulosic resin, about 72-50% of a plasticizer, and about 0-5% of a slip agent (stabilizer and/or release agent). The cellulosic resin is preferably an acetate, in an example cellulose acetate butyrate. The plasticizer may be any known plasticizer compatible with the resin. In an embodiment, it is biodegradable and non-toxic, as for example an ester of an edible acid, such as adipic acid or citric acid. The stabilizer and/or release agent preferably comprises a vegetable oil, such as an epoxidized soy bean oil. The coating may also optionally include an extender such as, for example, sucrose acetate isobutyrate (e.g., SAIB 90, Eastman Chemical Co., Eastport, Tenn., USA) in an amount up to about 15%, preferably 2-10%. The coatings preferably are stable and do not exude any oils or other liquids which may stain or damage the architectural pieces to which they are applied.

The coating composition is preferably ultraviolet resistant so that when the coated pieces are stored outdoors prior to use, the sun does not substantially alter the coating as to color or texture. The coating is also preferably biodegradable and non-toxic.

The coating, particularly when used on porous architectural pieces, is preferably not an adhesive, and clings to the upper surface of the architectural piece by at least partially filling pores or pits in the surface while the coating is in a liquid or semi-liquid state, before cooling. The coating preferably is applied to a room-temperature architectural piece and hardens within under a minute, typically in under thirty seconds, generally under about ten seconds.

The preferred coating cures at room temperature to form an architectural piece with a smooth, slick, low-friction coating. These characteristics of the coating allow a rubber squeegee to rub across the upper surface of a coated piece without peeling the coating off. They may also allow the architectural pieces to be stacked without damaging each other during handling, shipping, and laying of the piece in a desired pattern for the application of grout or other adhering material. The pieces can, if desired, be laid in a spaced-apart pattern on a backing sheet before shipment to form a composite veneer sheet.

The coating is preferably applied to an upper surface of the architectural pieces in such a way that grout or other filler applied between the pieces is below the coating when dried or cured.

The coating is preferably applied to the architectural pieces by spraying using automated equipment. Moving the individual pieces on a conveyor under a spray head which is activated by a sensor is presently preferred. However, other coating methods, such as dipping, brushing or roll-coating may also be used. For on-site application, a hand heater, like a conventional glue gun, can be used for touch-up or repair, it desired. If roll-coating is used, it is preferable to use a process in which the rollers are driven in a direction opposing their direction of movement relative to the architectural pieces, so as to screed the coating on thick enough to be peeled in one piece. The coating is applied at a desired thickness. Generally, the thickness should be at least great enough to provide complete coverage of the upper surface of the architectural element. Preferably, it is sufficiently thick that the entire coating is peelable as an integral piece. The coating may be as thick as desired. A thick coating may provide better abrasion resistance and cushioning in transport, although a thick coating is also more costly and may complicate applying grout to the desired thickness. Generally, a coating between about 0.015″ (0.38 mm) and about 0.125″ (3.2 mm) is preferred, a thickness of about 0.018″ (0.45 mm) to about 0.085″ (2.2 mm) being typical of presently preferred coatings. The preferred composition of the present invention is preferably applied at about one pound per ten to fifteen square feet (one kilogram per two to three square meters). These thicknesses are substantially greater than those achieved by previously known coatings and provide superior protection of the architectural pieces during shipping, handling, and grouting, as well as providing an easily stripped coating.

To form vertical veneers, the coated pieces are conveniently formed into a veneer by arranging and adhering them to an appropriate backer board (such as a plaster board sheet), arranged in a desired pattern with appropriate spaces between them for the application of grout. If the pieces are bricks arranged in a running bond, the veneer boards typically will either leave a place at the edge of the board for a single brick every other row, or else will leave space for two bricks in one row and one brick in the other; when the boards are abutted, the missing bricks are adhered over the joint to complete the wall.

The grouting process is easily achieved by applying grout over a selected pattern of the coated pieces using a suitable tool, e.g., a squeegee, screed, mop or the like to spread the grout across the face of the assembly, thereby pushing grout into all the joints. The joints may then be profiled as desired, using standard tools. Use of a mop (such as a propylene or neoprene mop) to move the grout may result in acceptable flat grout lines without hand profiling the grout lines.

After the grout is dried or cured, the coating is easily peeled intact from each architectural piece. Although the amount of force required will depend on the formulation of the coating and the surface of the architectural piece, the coating is easily peeled by hand from any architectural piece, ranging from tile to heavily aged (porous) brick; to sanded brick; to embossed, debossed, incised pieces; to stone, wood, or even glass pieces. . By way of illustration, the coating can preferably be removed from standard brick using less than a half pound per inch (≦96 g/cm) of force. In an embodiment forces of less than one-quarter pound per inch (≦48 g/cm) are required, illustratively in a range of from as little as about one-quarter ounce per inch or less (≦3 g/cm) up to one-quarter pound per inch (48 g/cm) are used. In other, presently less preferred embodiments, peeling forces of less than three pounds per inch (≦576 g/cm), typically about one pound per inch (192 g/cm), of force are used to remove the coating.

In an embodiment, the coating may be removed by the simple use of compressed air at a pressure of about 100-140 lbs/square inch (psi) (690-965 kpascal), delivered through a flexible hose and a standard nozzle held a few inches from a coated piece at an angle of about 50°; the air appears to ricochet off the edge of the coating, lifting and removing it. Use of an “air knife” spreading nozzle may make removal even more efficient. The coating may also be removed by hand, or by the use of a stiff brush, a rotary tool, or a vacuum tool, or other means known in the art. Removal by water jet is possible, but leaves the piece wet.

The coating simply peels off the architectural piece. Preferably, no residue from the coating or from the grout remains on the piece. Therefore, the clean-up of grout residue inherent in conventional application of grout to masonry, such as brick, stone, concrete, or tile, is eliminated. Further, no tedious clean-up is required, as would be required with such coatings such as latex or wax. The pieces, securely grouted or adhered in the desired pattern, are clean and dry and ready for application of any desired finishing compound. It will of course be understood that at the higher plasticizer levels of the inventive coatings, it is possible that a small amount of plasticizer or oil will sweat from the coating if the architectural piece is stored in the hot sun for an extended period; however, when the coating is removed, any amount of plasticizer on the surface of the piece will be insubstantial and will dissipate rapidly without leaving a stain or residue.

The coating material removed by peeling can be allowed to biodegrade. Preferably, however, it is recycled by cleaning, melting, filtering and blending it with another batch of the coating material.

For example, when laying a brick veneer patio, a layer of thin-set adhesive is applied to the surface onto which the veneer pieces are placed in the desired pattern, with their coated sides up. The veneer pieces are worked into the thin-set adhesive so the pattern holds its intended position. The grout is then spread across the entire surface without regard to each of the veneer piece surfaces. Application of the grout may be accomplished standing up using a squeegee or like tool to push the grout into the spaces between bricks and a mop to contour the grout. After the grout is cured, the coating is simply removed from each veneer piece by a simple peeling procedure. In an illustrative embodiment, the coating is removed with a stream of compressed air from a conventional air hose attached to a conventional air compressor.

Generally, when the pieces are for a patio or driveway, a concrete surface is laid before the pieces are laid. The concrete surface needs to be completely cured and accepting of water penetration to provide the preferred bond to any adhesive used and to the coated pieces laid by the process of the present invention.

The coated pieces are suitable for a patio, walkway or driveway surface. They may also be used for interior halls or flooring in homes or commercial buildings. In addition, they may be used on walls of buildings both exterior and interior, surrounding fire places or hearths, or for the exterior surfacing of a free-standing wall or other surface.

In one embodiment, it may be advantageous to attach the bottom surface of the coated pieces to a mesh like material or other substance in a desired pattern. The coated pieces attached to the mesh can be handled or shipped to the place of construction and simply laid out on the surface to which the coated pieces are to be attached. The grout is then applied without regard to the surface of the coated pieces. After curing of the grout, the coating on the pieces is removed by peeling the coating.

A new method for creating a brick or stone veneer wall using the coated veneer pieces starts with a preformed liner having a pattern for bricks embossed into the liner. The interior of the liner is sprayed with an adhesive and the coated bricks are laid into the embossed indentations with the coated side of the brick impacting the adhesive. The liner lies at the base of a form for forming a concrete wall. Concrete is poured generally up to about six inches in thickness, on top of the liner containing the coated bricks. After the concrete has dried and is cured, the concrete wall is put in place. The brick side of the wall still has the liner attached to it. When the liner is removed, the pieces of the coating are also removed with the liner. The brick wall is finished and requires no washing or cleaning.

Conventionally when brick veneer walls of this type are poured, water leaches in between the liner and the brick and stains the brick exterior so that following the removal of the liner, it is necessary to power wash the wall. When utilizing the coated brick veneer pieces of the present invention, the water from the concrete does not get between the coating and the brick so the brick comes out clean when the liner is removed.

The advantages of the present invention are numerous. The arduous task of grouting brick or stone or other architectural pieces piece by piece is eliminated. Each coated piece is completely clean after removal of the coating, thereby eliminating a messy cleaning process following grouting of brick or stone surfaces. Conventionally, a finish coating may be applied to the installed pieces and grout. Such architectural pieces provide a surface which requires substantially no care for a long period of time whether it be a driveway, a wall or a walkway surface.

The novel coatings of the present invention, the methods of coating, and the resulting architectural pieces all have applications beyond the illustrative embodiments described herein.

### BRIEF DESCRIPTION OF DRAWINGS

The objects of the invention are achieved as set forth in the illustrative embodiments shown in the drawings which form a part of the specification.

FIG. 1 is a perspective view of equipment carrying out an illustrative method of applying a coating to veneer pieces in accordance with one embodiment of the present invention;

FIG. 2 is a perspective view of a subsequent step to FIG. 1 of the method of the present invention;

FIG. 3 is a perspective view of another step of the method of the present invention;

FIG. 4 is a perspective view of a further step of the method of the present invention; and

FIG. 5 is an enlarged partial sectional view of a brick with a coating of the present invention applied to one face.

Corresponding reference characters indicate corresponding parts throughout the several views of the drawings.

### MODES FOR CARRYING OUT THE INVENTION

The following detailed description illustrates the invention by way of example and not by way of limitation. This description will clearly enable one skilled in the art to make and use the invention, and describes several embodiments, adaptations, variations, alternatives and uses of the invention, including what I presently believe is the best mode of carrying out the invention. As various changes could be made in the above constructions without departing from the scope of the invention, it is intended that all matter contained in the above description or shown in the accompanying drawings shall be interpreted as illustrative and not in a limiting sense.

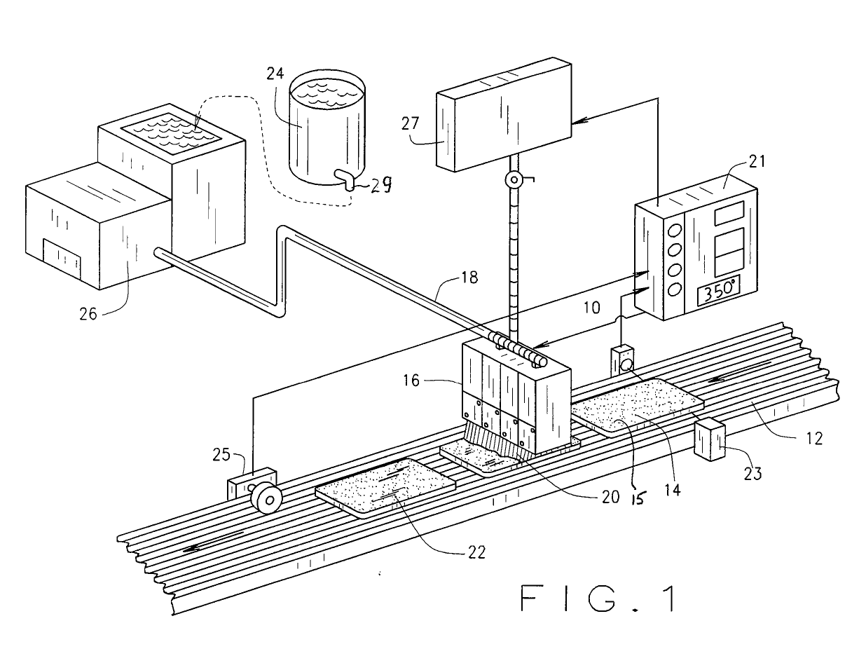

As shown in FIG. 1, an illustrative method of the present invention provides a simple and accurate method for applying a coating to one face only of an architectural piece. A spray applicator 10 is mounted above a conveyor 12. The conveyor 12 moves a veneer piece 14 (in this embodiment the architectural piece is a brick veneer) beneath a sprayer 16 which sprays a coating 20 onto the brick 14 passing beneath the sprayer 16. The coated brick 22 continues on the conveyor where it is cooled until the coating becomes solid and the brick 22 can be stored until time for its use. Typically, for a preferred cellulose acetate coating, the coating is heated to about 350° to 375° F. (176°-191 ° C.) at about twelve psi (seven kpascal), heated to about 390° F. (199° C.). The coating composition is formed in a mixer 24 and passed through a heating station/pump 26 where the coating composition is a free-flowing liquid. It will be understood that the composition may be produced off-site in a mixer 24, formed into blocks, pellets, granules, or the like, and shipped to the site of the applicator 10 where it is melted in heating station/pump 26. The liquid is then pumped through a heated insulated feeder pipe 18 to the sprayer 16 above the conveyor 12. The sprayer 16 is metered so as to spray only on the brick upper face 15 as it passes beneath the sprayer 16. The sprayer 16 is controlled by signals from a computer 21 which receives signals from an edge sensor 23 and a conveyor speed sensor 25 to trigger the on and off applications of the coating by the applicator 10. The conveyor speed is preferably kept substantially uniform, so the computer 21 need control only the on and off signals, without need to adjust the quantity of coating supplied based on conveyor speed. The bricks are preferably carefully aligned (as by guides) laterally of the conveyor belt, so that complete coverage of the face 15 of each brick is determined by choosing the spray head width to equal the width of the brick and making necessary upward and downward adjustments to make use of the spray fan to obtain accurate coverage from side to side of the brick. Coverage from front to back of the brick is obtained based on sensing leading and trailing edges of the brick by edge sensor 23 and appropriately delaying control signals from the computer 21 based on sensed conveyor speed.

Because the preferred coating is not an adhesive, but clings to the surface of the brick 14 by partial penetration of pores and fissures in the brick face, the brick needs no special preparation before it is coated.

In an embodiment, the spray applicator 10 is an Equity™ continuous slot die applicator sold by ITW Dynatec, Hendersonville, Tenn., USA. This applicator features Laminated Plate Technology (LPT) and produces Uniform Fiber Deposition (UFD). It is described in U.S. Pat. Nos. 5,882,573, 5,902,540, and 5,904,298, incorporated by reference herein. A standard 7″×2.5″ brick is accommodated by an array of fourteen orifices, arranged seven across and two deep. In each orifice, heated air from an air source 27 causes the spray to move side to side to provided complete coverage of the brick passing under the applicator head 16. Half width heads may be used to increase the width of spray in half-inch increments.

In an embodiment, the edge sensor 23 is a visible light laser/reflector pair. This sensor works well for generally rectangular pieces which can be coated accurately to the edges of the pieces, or can be coated to within a short distance from the edge if it is desired to have grout cover a small edge of the brick. For more complex shapes, it may be desirable to sense the entire outline of the shape and control the spray heads in a more complex way than simply turning them on and off at the same time in order to provide edge-to-edge coverage. If the conveyor belt is protected from overspray, it is also possible simply to spray beyond the edges of the piece and rely on the fan of the spray to prevent coverage of faces other than the upper face 15 of the piece.

Belt speed sensor 25 may be any of the many known sensor widely used in the conveyor art, preferably a high-precision sensor.

The belt 12 in an embodiment has a speed of from twenty to thirty feet per minute (6-9 m/minute), with the head spaced 1.25″ (3.2 cm) above the average height of the bricks 14 at an air pressure of fourteen psi (97 kpascal) to deliver 0.18 to 0.13 ounces (5-3.8 grams) of coating per brick. The mass of the brick 14 produces an efficient heat sink, allowing the coating 20 to harden almost instantaneously, on the order of less than thirty seconds to less than 10 seconds. This permits the bricks to be taken off the conveyor and handled a short distance down the conveyor from the applicator 10.

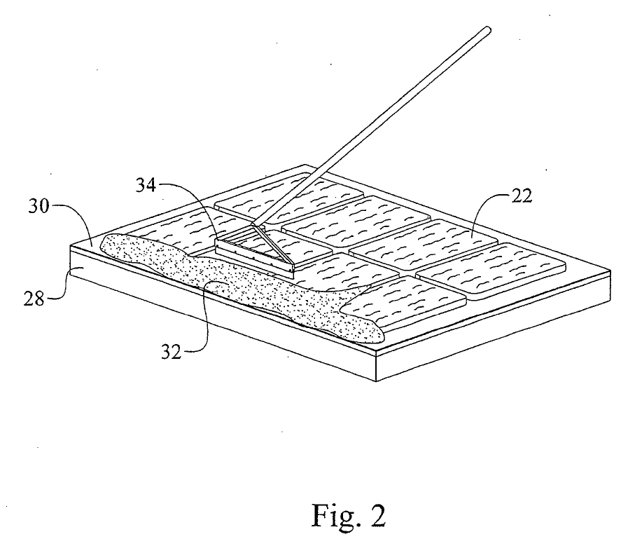

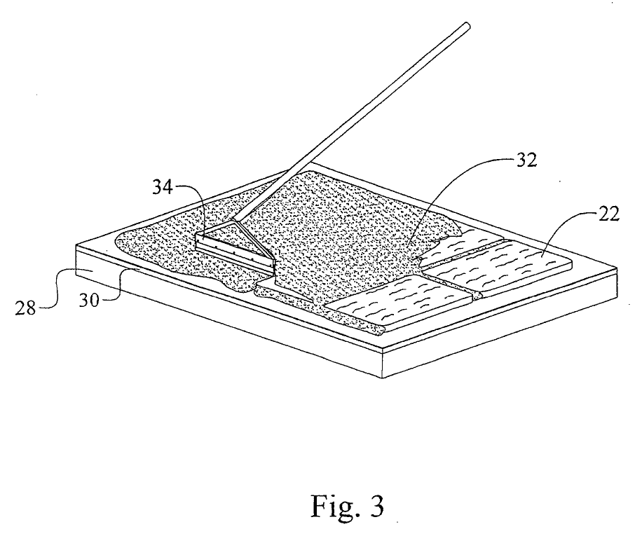

FIGS. 2 and 3 illustrate the ease with which grout 32 can be applied to a pattern of the coated bricks 22. Conventionally when laying a pattern of bricks 22 a base 28 is provided. The base 28 may be poured concrete, a wood floor or other suitable substrate. A layer of adhesive 30 is applied to the substrate 28 prior to laying the bricks 22 in their desired pattern. A suggested adhesive product is MegaLite Crack Prevention Mortar sold by Custom Building Products, Seal Beach, Calif. Products of this nature are identified in the industry as “thin-set” adhesive. The thin-set adhesive 30 is applied by use of a rake trowel to the surface 28 to be covered with the bricks 22. Grout 32 is applied without regard for the coated surfaces of the bricks 22. The grout 32 is simply applied over the entire surface of bricks 22 with a suitable applicator 34. As shown in FIG. 3 the surface of the bricks 22 may be substantially covered with grout 32 so as to fill all of the spaces between the bricks 22 with grout 32. The grout 32 on the surfaces of the bricks 22 is then swept away with a squeegee or other appropriate tool.

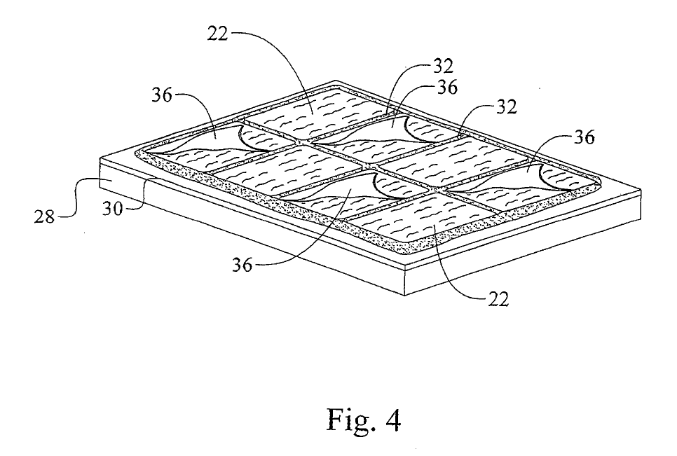

FIG. 4 illustrates the final step in the procedure of applying grout 32 to a pattern of coated bricks 22. The coating 36 on each brick 22 is simply peeled manually, mechanically, or with air from the brick 22 after the grout 32 has been cured. The surface of each brick 22 is clean and dry and ready for any finishing coating and the like. The peeled coating pieces 36 can be cleaned, remelted, filtered for debris, and reused either alone or after being recompounded for recycling to the heater/pump 26 of FIG. 1.

Advantages of the present invention are many. The coated pieces, after the coating has cooled and stabilized, can be packaged and shipped just as conventional architectural pieces are shipped. Since the coating of the architectural pieces is UV resistant, the coated pieces can be stored outside without damage to the coating or the pieces. The presence of the coating also helps to prevent chipping of the architectural pieces when shipping and handling.

Highly skilled labor is not required to build a patio or driveway surface or side to a building of architectural pieces resulting in a functioning and appealing finished product. In fact, the grout 32 can be applied to the entire surface (FIG. 3) and then the excess grout 32 is easily wiped away (FIG. 4) after which the grout 32 is cured and then the pieces of coating 36 are removed. A conventional sealant can then be applied, if desired.

### EXAMPLE 1

In an embodiment of the present invention, formulated for use on most brick, the following constituents are mixed in a heated mixer 24.

| | Parts by weight |
|---|---|
| Cellulose acetate butyrate | 28 |
| Di-isononyl phthalate, | 59 |
| Di-n-butly adipate | 10 |
| Epoxidized soy bean oil | 3 |

The liquid ingredients (plasticizers) are heated in a heated mixer 24 to about 300° F. (149° C.). Solids are added with slow agitation to disperse heat and evenly melt the polymer solids into the plasticizers without introducing air into the mixture. When the mixture is a clear, free-flowing liquid, it is released through a heated valve 29 at the bottom of the tank. If produced off-site, the liquid is poured into a mold or is extruded, cooled to form a solid, and cut into pellets or granules. Equipment for reducing the solid to chunks, pellets, pastilles, granules, and the like is well-known in the art and is available, for example from AB Sandvik Materials Technology, Sandviken, Sweden.

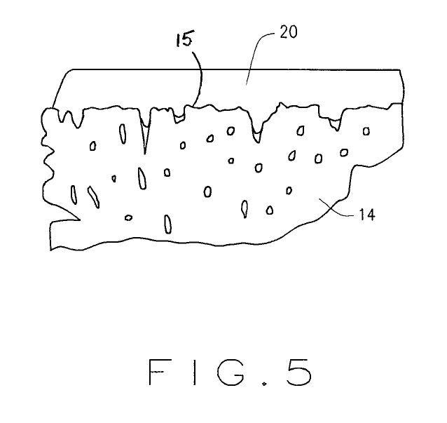

Whether the coating material is supplied as a pre-formulated solid to the applicator site or is formulated there, it is heated in heating station/pump 26 to a temperature of about 350° F. (177° C.), and pumped through an insulated pipe 18 to a spray applicator 16 as depicted in FIG. 1. The spray applicator 16 is provided hot compressed air from source 27 to maintain the temperature of the liquid being sprayed at approximately 350° F. The spray applicator 16 is programmed to spray substantially only the upper surface of the brick veneer piece 14 as the brick 14 passes beneath the spray 20. The coating 20 (FIG. 5) has a thickness of about 0.040″ (1 mm). As shown in FIG. 5, the liquid coating 36 enters pores in the brick surface and locks the coating to the upper surface sufficiently to prevent its being brushed off by laterally applied forces, such as a rubber or neoprene squeegee or a brick stacked on top of it. The coated bricks 22 are ready for handling, shipment, or use in less than thirty seconds, even in ambient room-temperature cooling conditions.

Upon cooling, the coating provides a relatively hard but flexible outer shell on the face of the brick, which allows the bricks to be placed face-to-face without adhering to each other. The coating has sufficient clarity to see through the coating to permit visual inspection of the product and the product color. The coating is both biodegradable and recyclable. The coating has a softening temperature of at least 170° F. (77° C.), so that the coating remains in its relatively hard shell condition when the coated pieces are stored outside. The coating prevents moisture from seeping under the coating when the coated pieces are stored or in the process of grouting. The coating is ultraviolet resistant and prevents damage from occurring when the coated pieces are stored outside in the weather.

The coating adheres to brick of any description. For example, sanded brick has become very popular as the exterior of a wall. When uncoated sanded bricks are placed in a liner as discussed above, the water from the concrete poured to form the wall stains the sanded brick while the concrete wall is curing. The brick then has to be power washed, but power washing tends to destroy a significant amount of the sand on the brick. When the coating of the present invention is utilized, the concrete water does not seep onto the sanded brick surface but the coating adheres to the brick surface until the coating is peeled from the surface of the sanded brick.

### EXAMPLE 2

In another example of the present invention, the following constituents are melted and mixed in a heated mixer 24:

| | Parts by weight |
|---|---|
| Cellulose acetate butyrate | 50 |
| Diisodecyl phthalate | 50 |
| Triethylene glycol | 2 |
| Diphenyl phosphate | 2 |
| Wax | 2 |

The mixed ingredients are heated in a heater/pump 26 to about 350° F., and applied in a manner similar to Example 1.

### EXAMPLE 3

In another example of the present invention, the following constituents are melted and mixed in a heated mixer 24:

| | Parts by weight |
|---|---|
| Cellulose acetate butyrate | 35 |
| Di-n-butyl adipate | 63 |
| Epoxidized soy bean oil | 2 |

The mixed ingredients are heated in a heater/pump 26 to about 350° F., and applied in a manner similar to Example 1.

### EXAMPLE 4

In another example of the present invention, utilizing only ingredients derived from renewable resources, the following constituents are melted and mixed in a heated mixer 24:

| | Parts by weight |
|---|---|
| Cellulose acetate butyrate | 45 |
| Acetyl tributyl citrate | 53 |
| Epoxidized soy bean oil | 2 |

The mixed ingredients are heated in a heater/pump 26 to about 350° F., and applied in a manner similar to Example 1.

### EXAMPLE 5

In another example of the present invention, the following constituents are melted and mixed in a heated mixer 24:

| | Parts by weight |
|---|---|
| Styrene-ethylene/butylene-styrene (SEBS) | 30 |
| Mineral oil | 65 |
| Kristalex hydrocarbon resin* | 5 |

*Eastman Chemical Co., from styrenic monomers

The mixed ingredients are heated in a heater/pump 26 to about 350° F., and applied in a manner similar to Example 1.

### EXAMPLE 6

In another example of the present invention, the following constituents are melted and mixed in a heated mixer 24:

| | Parts by weight |
|---|---|
| Styrene-ethylene/propylene-styrene (SEPS) | 30 |
| Mineral oil | 62 |
| Paraffin | 3 |
| Kristalex | 5 |

The mixed ingredients are heated in a heater/pump 26 to about 350° F., and applied in a manner similar to Example 1.

### EXAMPLE 7

In another example of the present invention, the following constituents are melted and mixed in a heated mixer 24:

| | Parts by weight |
|---|---|
| Cellulose acetate butyrate | 28 |
| Di-n-butyl adipate | 38 |
| Triethylene glycol | 31 |
| Epoxidized soy bean oil | 3 |

The mixed ingredients are heated in a heater/pump 26 to about 350° F., and applied in a manner similar to Example 1.

### EXAMPLE 8

In another example of the present invention, formulated for use on a less porous architectural piece such as tile, the following constituents are melted and mixed in a heated mixer 24:

| | Parts by weight |
|---|---|
| Cellulose acetate butyrate | 50 |
| Diisodecyl phthalate | 49 |
| Epoxidized soy bean oil | 1 |

The mixed ingredients are heated in a heater/pump 26 to about 350° F., and applied in a manner similar to Example 1.

### EXAMPLE 9

In another example of the present invention, the following constituents are melted and mixed in a heated mixer 24:

| | Parts by weight |
|---|---|
| Cellulose acetate butyrate | 20 |
| SAIB 90 | 8 |
| Di-n-butyl adipate | 38 |
| Triethylene glycol | 31 |
| Epoxidized soy bean oil | 3 |

The mixed ingredients are heated in a heater/pump 26 to about 350° F., and applied in a manner similar to Example 1.

The foregoing examples of a coating composition of the present invention are merely exemplary. Modifications of the formulation are included herein. For instance, there are several other thermoplastic resins which will work in the formulation of the coating. These are known to those skilled in the art. The same is true for the plasticizer. Plasticizers such as sebacates (e.g., di-2-ethylhexyl sebacate) may be used, as well as other adipates (e.g., di-2-ethylhexyl adipate), and other citrates (e.g., triethyl citrate and acetyl triethyl citrate). Although not presently preferred for environmental and potential health reasons, other phthalates and terephthalates (e.g., di-octyl terephthalate) may also be used as plasticizers. Other suitable stabilizers and/or release agents, such a fatty acids and their esters (e.g, stearic acid esters such as butyl stearate or oleic acid and its esters) are known to those skilled in the art.

It will be seen that the methods of using masonry pieces having a coating on one face results in a finished product which does not require power washing, acid washing, or other harsh or wasteful treatments of the finished architectural elements. Several of the illustrative embodiments of the composition are fully and rapidly biodegradable, compostable, or recyclable. Therefore, the present invention is environmentally friendly in several ways, in addition to reducing the labor and wastage of presently known approaches. The coatings and application methods of the invention may also be applied to other architectural elements in order to protect them during shipment and installation. The coatings of the invention may be applied to other substrates.

Numerous other variations in the coatings, methods, and products of the present invention, within the scope of the appended claims, will occur to those skilled in the art, and all such variations are intended to be covered by the claims.

### INDUSTRIAL APPLICABILITY

The invention finds industrial applicability in the industry of protective coatings, in the industry of architectural materials, in the masonry industry, and in the construction industry, among others.

1. A thermoplastic coating composition suitable for coating the upper surface of an architectural piece, which comprises a cellulosic thermoplastic resin and a plasticizer and optionally minor portions of a stabilizer and a release agent in such proportions that the resulting mixture when mixed and melted and applied to the upper surface of an architectural piece and cooled provides a coating which has a softening point above about 170° F. (77° C.), has a low friction surface, is waterproof, has a low tack and is easily peelable from the architectural piece.

2. The coating composition of claim 1 wherein the cellulose is cellulose acetate butyrate.

3. The coating composition of claim 1 or 2 wherein the plasticizer comprises di-isononyl phthalate, di-octyl terephthalate, di-n-butyl adipate, acetyl tributyl citrate, or triethyl citrate.

4. The coating composition of claim 1 wherein the plasticizer comprises an ester of an edible acid.

5. The coating composition of claim 4 wherein the plasticizer comprises an adipate, a sebacate, or a citrate.

6. The coating of claim 1 wherein the plasticizer comprises di-isononyl phthalate.

7. The coating composition of claim 1 wherein the composition comprises a fatty acid or a glycerin ester of a fatty acid as a release agent.

8. The coating composition of claim 1 wherein the composition comprises an epoxidized soy bean oil as a stabilizer and release agent.

9. An architectural piece having a thermoplastic coating substantially completely covering an upper surface thereof, all other surfaces of the architectural piece being substantially free of the thermoplastic coating, the thermoplastic coating being peelable intact from the architectural piece.

10. The coated architectural piece of claim 9 wherein the coating which has a softening point above about 170° F. (77° C.).

11. The coated architectural piece of claim 9 wherein the coating has a low friction surface, is waterproof, and has a low tack.

12. The coated architectural piece of claim 9 wherein the coating is peelable using less than four ounces per inch (48 g/cm) of pull.

13. The coated architectural piece of claim 9 wherein the architectural piece is selected from the group consisting of concrete, structural stone, wood, glass, porcelain, plastics, structural brick, pavers, brick veneer, and stone veneer.

14. The coated architectural piece of claim 9 wherein the architectural piece is selected from the group consisting of concrete, stone, and brick.

15. The coated architectural piece of claim 9 wherein the coating comprises major portions of a thermoplastic resin and a plasticizer and optionally minor portions of a stabilizer or a release agent or both.

16. The coated architectural piece of claim 15 wherein the thermoplastic resin is cellulose acetate butyrate.

17. The coated architectural piece of claim 15 wherein the plasticizer is dioctyl terephthalate or triethyl citrate.

18. The coated architectural piece of claim 15 wherein the release agent is butyl stearate.

19. The coated architectural piece of claim 15 wherein the plasticizer comprises an ester of an edible acid.

20. The coated architectural piece of claim 19 wherein the plasticizer comprises an adipate or a citrate.

21. The coated architectural piece of claim 15 wherein the coating comprises an epoxidized soybean oil.

22. A method for grouting coated architectural pieces, each piece comprising a thermoplastic coating substantially covering one face of the piece, the method comprising:
a. fixing the architectural pieces in a predetermined pattern having spaces between the pieces,
b. applying grout or an adhering material over the coated pieces without regard for the coated pieces,
c. spreading the grout into the spaces between the pieces, and
d. removing the thermoplastic coating intact from the architectural pieces.

23. The method of claim 22 comprising a step of recycling coatings removed from the pieces.

24. A method for making a concrete wall having brick or stone veneer pieces which comprises:
a. providing an embossed liner having a desired pattern to hold the veneer pieces in place in the base of a concrete wall form;
b. spraying an adhesive onto the embossed liner;
c. placing coated veneer pieces onto the liner with the coated side of the veneer pieces contacting the adhesive on the liner;
d. pouring concrete into the concrete wall form;
e. allowing the concrete to cure forming a concrete wall;
f. removing the form from the concrete wall; and
g. removing the liner along with the coating from the veneer pieces resulting in a concrete wall containing veneer pieces.

25. The method of claim 24 wherein the coated veneer pieces are brick veneer pieces.

26. A coating composition suitable for coating the upper surface of an architectural piece, which comprises major portions of cellulose acetate butyrate and a plasticizer and minor portions of epoxidized soy bean oil in such proportions that the resulting mixture when mixed and melted and applied to the upper surface of an architectural piece and cooled provides a coating which has a softening point above about 170° F., a low friction surface, is waterproof, has a low tack and is peelable from the architectural piece.

27. The coating composition of claim 26 wherein the composition is biodegradable.

28. The coating composition of claim 26 wherein the plasticizer is a citrate or adipate.

29. The coating composition of claim 26 wherein the plasticizer is di n-butyl adipate or acetyl tributyl citrate.

30. The coating composition of claim 26 wherein the coating is recyclable.
